(19) United States
(12) Patent Application Publication
(10) Pub. No.: US 2008/0036220 A1
(43) Pub. Date: Feb. 14, 2008

(54) Door locking system

(76) Inventor: Pempa Tashi, New York, NY (US)

Correspondence Address: SUNG I. OH, PROFESSIONAL LAW CORPORATION, 710 QUAIL VALLEY LANE, WEST COVINA, CA, 91791, US

(21) Appl. No.: 11/500,857

(22) Filed: Aug. 8, 2006

(51) Int. Cl. E05B 15/02

(52) U.S. Cl. 292/340

(57) ABSTRACT

A lock guard system includes a shield which overlies the jamb face of a door in surrounding relation to the keeper recess in the jamb. The shield blocks insertion of a tool or device from movement toward the latch or lock bolt to be interposed between the lock latch and the keeper so such inserted device can be used to jimmy the latch out of the recess and thereby free the door from the jamb.

### TECHNICAL FIELD OF THE INVENTION

The present invention relates to the general art of locks, and to the particular field of accessories for door locks.

### BACKGROUND OF THE INVENTION

Hotels, motels and other transient residential establishment are constantly confronted with the problem of assuring that their guests are secure in their rooms and that no unauthorized persons will be able to gain access to such rooms when the guests are away. When guests are in their rooms, they are able to use the dead bolt locks or chains usually provided to prevent entry. It would be unduly burdensome for all concerned, however, to require guests to use double keys or submit to tedious identification procedures as an expedient for thwarting would-be thieves or intruders when the guests are not in their rooms. Therefore, continuing efforts have been made to find ways and means of preventing guest room doors from being opened, other than with keys intended for that purpose.

Almost invariably, doors to guest rooms open inwardly. Such doors are provided with spring-loaded latches which engage in suitably aligned apertures in cooperating striker plates on the door jambs. The spring-loaded latch or bolt is provided on the side which first contacts the striker plate with an oblique or slanted face so that as the door is closed, the bolt is caused to retract by reason of the striker plate pressure on the slanted face until the bolt is in position opposite the cooperating aperture in the striker plate, when spring pressure causes the bolt to be thrust into the aperture. The opposite face of the bolt is not slanted, so that in order to operate the retraction mechanism, it is necessary to turn the doorknob engaged therewith to disengage the bolt from the aperture. Normally, the retraction mechanism can be operated only from inside the room without a key. From the outside, it is necessary to use a key to cause the bolt to retract from the striker plate.

The big problem with such locks has been the fact that there is usually enough space between the door and the striker plate, and the trim on the door jamb against which the door is engaged when it is closed, to enable a dexterous person to insert jimmying tools, shims or even flexible plastic credit cards in that space in such a manner as to exert pressure on the slanted face of the bolt and it to retract, thus becoming disengaged from the aperture in the striker plate and allowing the door to be opened.

Furthermore, it is well known that burglars and other individuals desiring to make an unauthorized entry through a locked door often gain entry by inserting a flexible tool, such as a strip of plastic or of thin metal or a jimmy bar between a closed door and the door jamb and then work the flexible tool to force the lock bolt or latch away from the door jamb and back into the door so that the door is free to open.

A number of devices have been developed in an effort to combat the problem of unauthorized entry through locked doors. The devices available today have had the following drawbacks: some are quite complicated and expensive to make; others require extensive modification of the doors or door jambs in order to be installed and none of the devices provide adequate protection against unauthorized entry by force which splits the lock mechanism away from the door and door jamb.

Therefore, there is a need for a device that is easy to install and which will effectively prevent insertion of a flexible jimmying device into the latch bolt accommodating recess defined in the door jamb between the latch bolt and the door jamb so as to free the latch bolt from the door jamb.

### SUMMARY OF THE INVENTION

The above-discussed disadvantages of the prior art are overcome by a lock guard which includes a shield which overlies the jamb face of a door in surrounding relation to the keeper recess in the jamb. The shield blocks insertion of a tool or device from movement toward the latch or lock bolt to be interposed between the lock latch and the keeper so such inserted device can be used to jimmy the latch out of the recess and thereby free the door from the jamb.

Using the lock guard embodying the present invention will prevent insertion of flexible jimmying devices into the lock to open a door. The lock guard is easy to install and thereby can be easily retrofit to an existing door.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a top plan view of a door lock shield embodying the present invention.

FIG. 2 is an enlarged view of a portion of the door lock shield shown in FIG. 1.

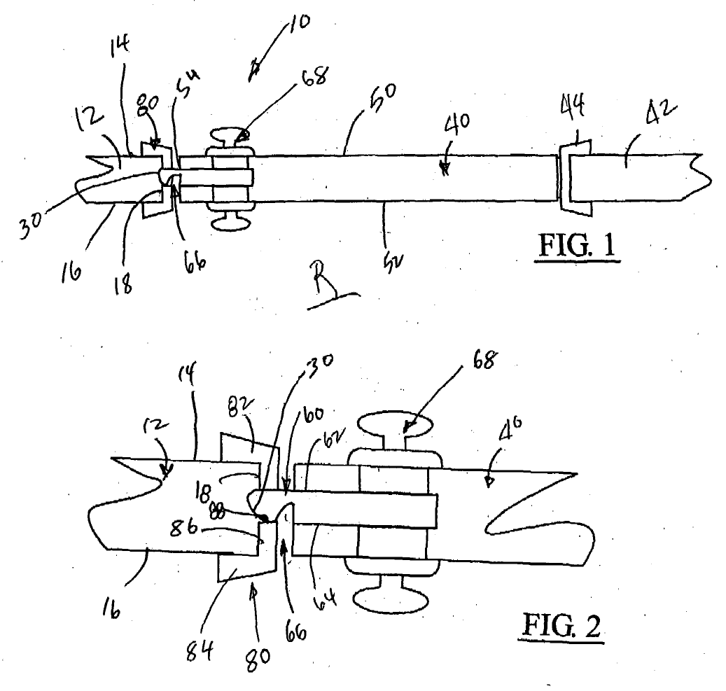

### DETAILED DESCRIPTION OF THE INVENTION

Referring to the figures, it can be understood that the present invention is embodied in a door lock shield system 10 which can be easily placed on a door so it can be placed during initial installation or retrofit as needed. System 10 comprises a door jamb 12 which has a first surface 14 which is an outside surface with respect to a room R associated with the door jamb, a second surface 16 which is an inside surface with respect to the room associated with the door jamb and an edge 18 which connects first surface 14 to second surface 16.

A latch bolt accommodating recess 30 is defined in edge 18 of the doorjamb. A door 40 is movably mounted on a wall 42 associated with the door jamb. Molding 44 can be interposed between the door and the wall if suitable. Door 40 has a first surface 50 which is an outside surface with respect to room R associated with the door jamb, a second surface 52 which is an inside surface with respect to room R associated with the door jamb, and an edge 54 connecting first surface 50 of the door to second surface 52 of the door.

A latch bolt 60 is movably on edge 54 of the door. Latch bolt 60 has a first surface 62 which is an outside surface with respect to room R associated with the door, a second surface 64 which is an inside surface with respect to room R, and a notch 66 on inside surface 64 of the latch bolt. Latch bolt 60 is movably mounted on the door and is movable between an extended position shown in the figures and a retracted position. The extended position has the notch located outside the door and the retracted position has the notch located inside the door.

A handle 68 is located on the door and is connected to the latch bolt to move the latch bolt between the extended position and the retracted position. The connection between the handle and the latch bolt is well known to those skilled in the art. The details of the connection between the handle and the latch bolt are not important to this invention and thus will not be discussed or claimed.

The door is movable between a closed orientation shown in the figures in which the edge of the door is located adjacent to the edge of the door jamb and the latch bolt is received in the latch bolt accommodating recess defined in the edge of the door jamb when the latch bolt is in the extended position and an open orientation in which the edge of the door is spaced apart from the edge of the door jamb.

A one-piece U-shaped shield 80 is mounted on door jamb 12 adjacent to latch bolt accommodating recess 30 and includes a first leg 82 which is in abutting overlying contact with first surface 14 of door jamb 12, a second leg 84 which is in abutting overlying contact with second surface 16 of the door jamb, and a bight section 86 which connects first leg 82 of the shield to second leg 84 of the shield and which is in abutting overlying contact with edge 18 of door jamb 12. Bight section 86 of the shield extends over latch bolt accommodating recess 30 and includes a slot 88 defined therethrough. Slot 88 in the bight section of the shield is located adjacent to latch bolt accommodating recess 30. Slot 88 is located so latch bolt 60 extends through slot 88 when the latch bolt is in the extended position and when the door is in the closed orientation. Bight section 86 of the shield covers latch bolt accommodating recess 30 and, with the exception of the latch bolt extending through slot 88, prevents access to latch bolt accommodating recess 30 defined in the edge of the door jamb.

Once shield 80 is in place, a jimmying device, such as a credit card, or a special jimmying tool, cannot be inserted into recess 30 between the latch bolt and the door jamb. Thus, such jimmying device cannot be used to free the latch bolt from engagement with the door jamb, and the door can remain locked when it is closed. The latch bolt can only be freed from the door jamb and the door freed for opening by operating the door handle mechanism, which can be controlled by a key or other such device which is in the control of a person who is authorized to open the door. The one-piece nature of the shield makes it easy to manipulate for installation yet strong once it is installed.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A door lock shield system comprising:
A) a door jamb having
(1) a first surface which is an outside surface with respect to a room associated with the door jamb,
(2) a second surface which is an inside surface with respect to the room associated with the doorjamb,
(3) an edge connecting the first surface to the second surface, and
(4) a latch bolt accommodating recess defined in the edge of the doorjamb,
B) a door movably mounted on a wall associated with the door jamb, the door having
(1) a first surface which is an outside surface with respect to the room associated with the door jamb,
(2) a second surface which is an inside surface with respect to the room associated with the door jamb,
(3) an edge connecting the first surface of the door to the second surface of the door,
(4) a latch bolt movably on the edge of the door, the latch bolt having
(a) a first surface which is an outside surface with respect to the room associated with the door,
(b) a second surface which is an inside surface with respect to the room associated with the door,
(c) a notch on the inside surface of the latch bolt, and
(d) the latch bolt being movable between an extended position and a retracted position, with the extended position having the notch located outside the door and the retracted position having the notch located inside the door,
(5) a handle on the door, the handle being connected to the latch bolt to move the latch bolt between the extended position and the retracted position,
(6) the door being movable between a closed orientation in which the edge of the door is located adjacent to the edge of the doorjamb and the latch bolt is received in the latch bolt accommodating recess defined in the edge of the doorjamb when the latch bolt is in the extended position and an open orientation in which the edge of the door is spaced apart from the edge of the doorjamb; and
C) a one-piece U-shaped shield mounted on the door jamb adjacent to the latch bolt accommodating recess defined in the edge of the doorjamb, the shield including
(1) a first leg which is in abutting overlying contact with the first surface of the doorjamb,
(2) a second leg which is in abutting overlying contact with the second surface of the door jamb, and
(3) a bight section connecting the first leg of the shield to the second leg of the shield and which is in abutting overlying contact with the edge of the doorjamb, the bight section of the shield extending over the latch bolt accommodating recess defined in the edge of the doorjamb and including a slot defined therethrough, the slot in the bight section of the shield being located adjacent to the latch bolt accommodating recess defined in the edge of the doorjamb, the slot defined through the bight section of the shield being located so the latch bolt extends through the slot when the latch bolt is in the extended position and when the door is in the closed orientation, the bight section of the shield covering the latch bolt accommodating recess defined in the edge of the doorjamb and with the exception of the latch bolt extending through the slot preventing access to the latch bolt accommodating recess defined in the edge of the doorjamb.

2. A door lock shield system comprising:
A) a door jamb having
(1) a first surface which is an outside surface with respect to a room associated with the door jamb,
(2) a second surface which is an inside surface with respect to the room associated with the doorjamb,
(3) an edge connecting the first surface to the second surface, and
(4) a latch bolt accommodating recess defined in the edge of the door jamb,
B) a door movably mounted on a wall associated with the door jamb, the door having
(1) an edge, and
(2) a latch bolt movably on the edge of the door, the latch bolt being movable between an extended position and a retracted position,
(3) the door being movable between a closed orientation in which the edge of the door is located adjacent to the edge of the doorjamb and the latch bolt is received in the latch bolt accommodating recess defined in the edge of the doorjamb when the latch bolt is in the extended position and an open orientation in which the edge of the door is spaced apart from the edge of the doorjamb; and
C) a one-piece U-shaped shield mounted on the doorjamb adjacent to the latch bolt accommodating recess defined in the edge of the doorjamb, the shield including
(1) a first leg which is in abutting overlying contact with the first surface of the doorjamb,
(2) a second leg which is in abutting overlying contact with the second surface of the door jamb, and
(3) a bight section connecting the first leg of the shield to the second leg of the shield and which is in abutting overlying contact with the edge of the door jamb, the bight section of the shield extending over the latch bolt accommodating recess defined in the edge of the door jamb and including a slot defined therethrough, the slot in the bight section of the shield being located adjacent to the latch bolt accommodating recess defined in the edge of the door jamb, the slot defined through the bight section of the shield being located so the latch bolt extends through the slot when the latch bolt is in the extended position and when the door is in the closed orientation, the bight section of the shield covering the latch bolt accommodating recess defined in the edge of the door jamb and with the exception of the latch bolt extending through the slot preventing access to the latch bolt accommodating recess defined in the edge of the doorjamb.
